(19) United States
(12) Patent Application Publication
(10) Pub. No.: US 2008/0232976 A1
(43) Pub. Date: Sep. 25, 2008

(54) SHOWER FLOW SIMULATOR

(76) Inventor: Andrew WHITTAKER, Burnley (GB)

Correspondence Address: Fleit Gibbons Gutman Bongini & Bianco PL, 21355 EAST DIXIE HIGHWAY, SUITE 115, MIAMI, FL, 33180, US

(21) Appl. No.: 12/049,611

(22) Filed: Mar. 17, 2008

(30) Foreign Application Priority Data
Mar. 24, 2007 (GB) 0705681.5

(51) Int. Cl. F04B 49/02; H02H 7/08

(52) U.S. Cl. 417/20; 417/44.1; 307/118; 318/481

(57) ABSTRACT

A method of simulating water flow through a shower waste pump which is controllable by a water-flow detector, the method comprising the step of by-passing the water-flow detector with a water-flow simulator device. The in use simulator device simulates the presence of water and thus causes the shower waste pump to operate without the need for water. A water-flow simulator device is also provided.

### BACKGROUND OF THE INVENTION

The present invention relates to a method of simulating water flow through a shower waste pump which is controllable by a water-flow detector, and to a water-flow simulator device for use with such a method.

Showering systems which utilise a pumped waste sump or trap drainage are known. The more advanced types of such pumped shower wastes, for example the Digipump® range from AKW Medicare Limited of Droitwich Spa, United Kingdom utilise turbine-type pulse generating flow sensors which relay a signal proportional to the flow of water entering a shower water heater or shower head to the drain pump controller.

The shower drain pump controller then varies the power supplied to the drain pump to effect variations in the pumping rate, based on initial configuration and setting up activities completed at installation and commissioning where the performance of the pump has been calibrated beforehand.

Flow sensors per se are sensitive instrumentation devices which are easily damaged if not carefully installed with filter or strainer fittings upstream of them in the water supply flowing through them. This is necessary to avoid blockages caused by detritus in the water which may prevent the, typically turbine, rotor in such devices functioning.

Thus it can be difficult and time-consuming for a service technician or an installer to identify faulty conditions in such prior art installations, thus requiring the installer or service technician to remove and replace the or each sensor during a fault-finding procedure.

Furthermore, when sales staff wish to demonstrate the operation of such products to potential customers, they are currently required to arrange a visit with the prospective customer to a site where the product has been installed previously into a water supply to a shower. This may involve extensive travel and inconvenience to both seller and prospective purchaser, particularly if one of them uses a wheelchair.

The present invention seeks to overcome these problems.

### SUMMARY OF THE INVENTION

According to a first aspect of the invention, there is provided a method of simulating water flow through a shower waste pump which is controllable by a water-flow detector, the method comprising the step of by-passing the water-flow detector with a water-flow simulator device, the in use simulator device simulating the presence of water and thus causing the shower waste pump to operate.

According to a second aspect of the invention, there is provided A water-flow simulator device for simulating water flow through a shower waste pump which is controllable by a water-flow detector, the device comprising a hand-holdable housing, circuitry provided within the housing which in use outputs an electronic water-flow signal indicative of water flow, a user interface provided on the housing which in use controls the water-flow signal, and a connector which in use electronically connects the device to a water-flow detector connector provided on pump control circuitry which electronically controls the shower waste pump.

The present invention will now be more particularly described, by way of example only, with reference to the accompanying drawings.

### BRIEF DESCRIPTION OF THE DRAWINGS

FIG. 1 shows an exploded perspective view from above of one embodiment of a water-flow simulator device, in accordance with the second aspect of the invention;

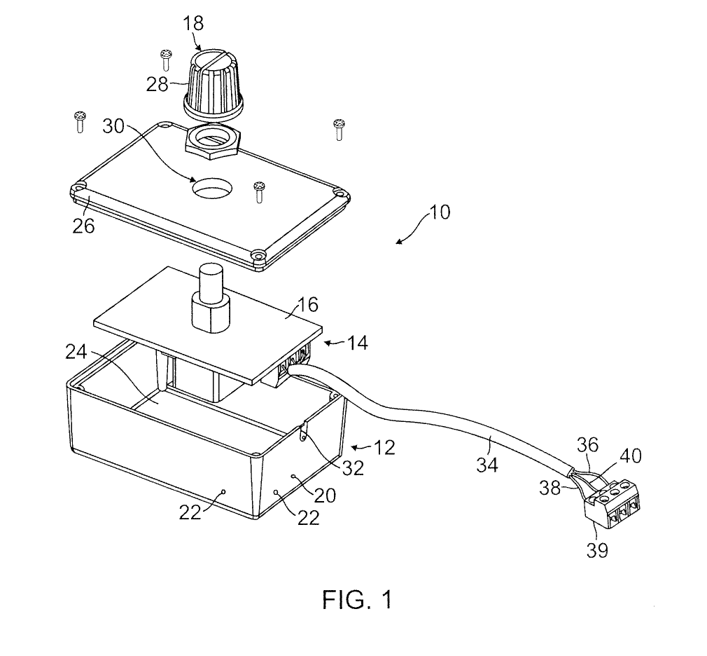

FIG. 2 shows an exploded perspective view from below of the water-flow simulator device; and

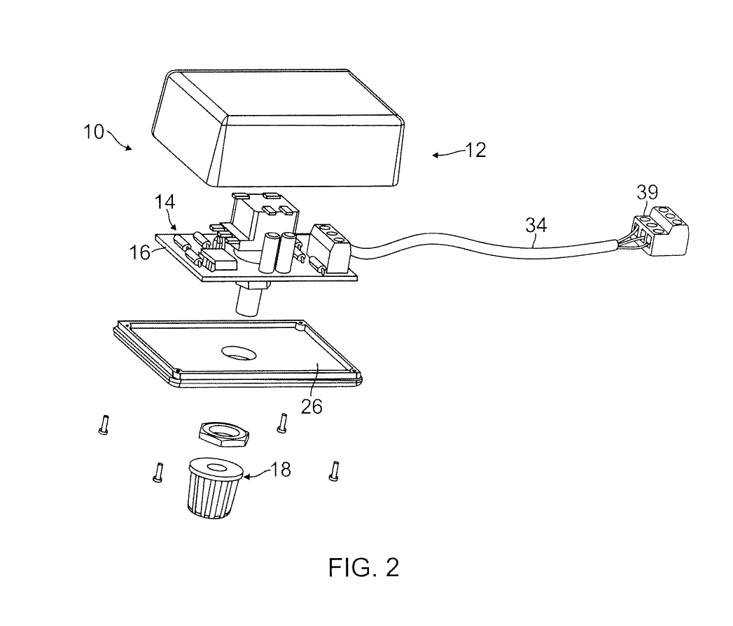

FIG. 3 shows a circuit diagram of circuitry of the water-flow simulator device.

### DESCRIPTION OF THE PREFERRED EMBODIMENTS

Referring to the drawings, there is shown a water-flow simulator device 10 which comprises a box-shaped housing 12, control circuitry 14 which is provided on a PCB 16 mounted within the housing 12, a user interface 18 which is provided on the housing 12, and a connector 39 for electronically connecting the device to a water-flow detector connector provided on pump control circuitry for electronically controlling the shower waste pump.

The housing 12 comprises a hand-holdable container 20 having four contiguous walls 22 and a base 24, and a, preferably gasketed, lid 26 locatable on the four walls 22 and opposite the base 24 to preferably water-tightly close the housing 12. The PCB 16 is dimensioned to fit without the housing 12, and the user interface 18 is in the form of a rotary control knob 28 which is mounted on the PCB 16 and which is received through an aperture 30 in the lid 26. The PCB 16 is thus fixed to the lid 26 via the rotary control knob 28.

Although the user interface 18 of this embodiment is a rotary control knob, an electronic interface, or any other suitable interface, can be provided.

One wall 22 of the housing 12 includes a notch 32, preferably having a water-tight cable gland, for receiving a three-wire cable 34 which typically comprises connections for a positive voltage supply 36, a negative voltage supply 38, and a pulsed return signal 40 proportional to water flow. One end of the cable 34 is received in the housing 12 and is connected to the control circuitry 14, and the other end of the cable 34 is exterior of the housing 12 and terminates in the connector.

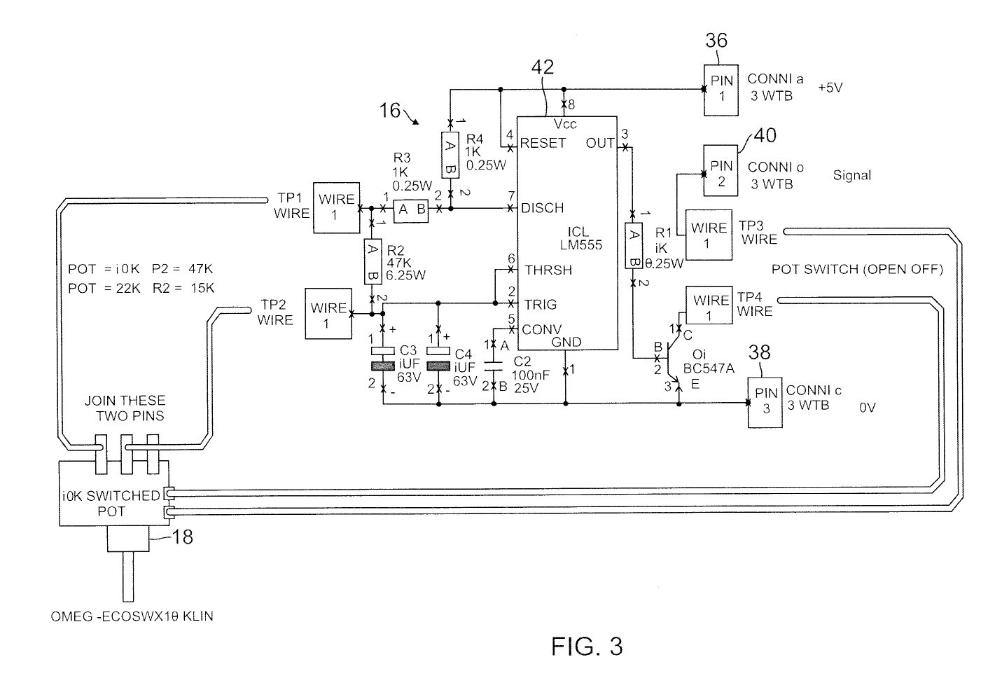

The control circuitry 14 on the PCB 16 is shown in FIG. 3. The control circuitry 14 is powered via the three-wire cable 34. The rotary control knob 28 advantageously includes an on-off switch and a variable resistor or potentiometer. Both functions can be provided by the ECOSWX10KLIN device made by OMEG Limited of East Grinstead, United Kingdom. The first approximately ten degrees of rotation operates the on-off switch, and further rotation varies the resistance of the potentiometer.

The control circuitry 14 includes a pulse signal generator 42. Variance in the output of the potentiometer, for example when operated by a user, varies an output of the pulse signal generator 42.

The water-flow simulator device 10 is only suitable for use in simulating water flow through a shower waste pump which is controllable by a water-flow detector. The water-flow detector is typically a turbine-type sensor having an electronic output, as described above, although other types of sensor can be utilised, such as capacitative or float-operable.

The water-flow detector is often incorporated within a shower unit having a shower head for the discharge of water. When the shower unit is operated to produce water flow from the shower head, the water-flow detector outputs a signal indicative of the flow rate to pump control circuitry. The pump control circuitry then controls the shower waste pump according to the signal. In this way, the pumping rate is automatically controlled based on the water flow rate.

To simulate water flow, the pump control circuitry is accessed by the installer, service technician or sales staff, and the water-flow detector is by-passed with the simulator device 10. Typically, the water-flow detector is simply unplugged from the connector on the pump control circuitry, and the connector of the simulator device 10 is plugged in.

When the user operates the rotary control knob 28, pulsed flow simulation signals are outputted by the simulator control circuitry 14 to the pump control circuitry. This electronically simulates flowing water, and the pump control circuitry controls the pump accordingly.

It will be appreciated that the water-flow detector may be provided externally of the shower unit, for example, within the water-supply pipe feeding the shower unit, at or within a drain or sump of the shower installation, at or within a drain pipe, or at or within a pump housing of the pump.

It will also be understood that more than one water-flow detector may be provided within the shower installation, and that the simulator device can be connectable to by-pass one, more or all of the detectors.

It is also envisaged that, with multiple flow-detectors, the simulator device is able to output a plurality of independent signals to the detectors to control the shower waste pump or alternatively multiple simulators may be beneficially connected simultaneously. Such devices may be conveniently housed in a single enclosure 12 which is provided with multiple adjustment means 18.

It is possible to provide a dedicated input on the pump control circuitry for simplified connection of the simulator device. The dedicated input can by-pass the or each water-flow detector without disconnection of the respective water-flow detector.

The simulator device is independently controllable by a user. However, the simulator device can, alternatively or additionally, include a microprocessor and a data storage device allowing automated control of the pump via one or more routines stored on the data storage device, once the simulator device is connected to the pump control circuitry.

Other modifications will be readily apparent to the skilled addressee. For example, variations to the basic control system such as replacing the discreet component control circuit shown in FIG. 3 with a Programmable Interrupt Controller (PIC) and fewer conventional parts will be evident.

It is thus possible to provide a water-flow simulator device for simulating water flow through a shower waste pump which is controllable by a water-flow detector. It is also possible to provide a method of by-passing the water-flow detector in a shower installation by the use of a simulator. Consequently, an installer or service technician can easily determine a faulty water-flow detector in a shower installation without the need to run water, and sales staff can demonstrate or exhibit a pumped shower waste without requiring water.

The embodiments described above are given by way of examples only, and various other modifications will be apparent to persons skilled in the art without departing from the scope of the invention, as defined by the appended claims.

What is claimed is:

1. A method of simulating water flow through a shower waste pump which is controllable by a water-flow detector, the method comprising the step of by-passing the water-flow detector with a water-flow simulator device, the in use simulator device simulating the presence of water and thus causing the shower waste pump to operate.

2. A method as claimed in claim 1, wherein the water-flow detector is connected to pump control circuitry for electronically controlling the shower waste pump, and the simulator device is an electronic simulator device.

3. A method as claimed in claim 2, wherein the water-flow detector is disconnected from the pump control circuitry, and the electronic simulator device is connected in its place.

4. A method as claimed in claim 1, wherein the simulator device is independently controllable by a user.

5. A method as claimed in claim 1, wherein the water-flow detector is provided at a location which is remote from the shower waste pump.

6. A method as claimed in claim 1, wherein the water-flow detector is provided in a shower unit having a shower head for the discharge of water.

7. A method as claimed in claim 1, wherein the water-flow detector is provided in a water-supply pipe which feeds a shower unit having a shower head for the discharge of water.

8. A method as claimed in claim 1, wherein the water-flow detector is provided on or in the vicinity of the shower waste pump.

9. A method as claimed in claim 1, wherein the shower waste pump is automatically operable by the water-flow detector.

10. A method as claimed in claim 1, wherein a plurality of water-flow detectors are provided, and the simulator device can by-pass one or more of the water-flow detectors.

11. A method as claimed in claim 1, wherein a plurality of water-flow detectors are provided, and the simulator device is controllable to simulate water flow at one, more or all of the water-flow detectors.

12. A method as claimed in claim 1, wherein the or each water-flow detector is a sensor having an electrical output.

13. A water-flow simulator device for simulating water flow through a shower waste pump which is controllable by a water-flow detector, the device comprising a hand-holdable housing, circuitry provided within the housing which in use outputs an electronic water-flow signal indicative of water flow, a user interface provided on the housing which in use controls the water-flow signal, and a connector which in use electronically connects the device to a water-flow detector connector provided on pump control circuitry which electronically controls the shower waste pump.

14. A water-flow simulator device as claimed in claim 13, wherein the circuitry within the housing includes a microprocessor and a data storage device, a flow routine being provided on the data storage device.

15. A water-flow simulator device as claimed in claim 13 for use with the method as claimed in claim 1.
